(19) United States
(12) Patent Application Publication
(10) Pub. No.: US 2007/0183685 A1
(43) Pub. Date: Aug. 9, 2007

(54) Image combining apparatus, image combining method and storage medium

(76) Inventors: Toshiaki Wada, Tama-shi (JP); Masashi Nakada, Matsudo-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/701,813

(22) Filed: Feb. 1, 2007

(30) Foreign Application Priority Data
Feb. 6, 2006 (JP) 2006-028446
Jan. 5, 2007 (JP) 2007-000621

(51) Int. Cl. G06K 9/36

(52) U.S. Cl. 382/285

(57) ABSTRACT

The invention provides an image combining method of an image processing apparatus for processing a plurality of images photographed by a photographic device, the method includes generating a virtual three-dimensional space on a display on which an image is displayed, and displaying a spherical surface or a frame expressing a spherical surface in the virtual three-dimensional space, selecting images, arranging the selected images on the spherical surface or the frame expressing a spherical surface, moving a visual point from which the spherical surface or the frame expressing a spherical surface is observed, carrying out a rotating operation, or a parallel moving operation onto the images arranged on the spherical surface or the frame expressing a spherical surface, in accordance with an operation instruction, and combining the plural operated images into one image.

### CROSS-REFERENCE TO RELATED APPLICATIONS

This application is based upon and claims the benefit of priority from prior Japanese Patent Applications No. 2006-028446, filed Feb. 6, 2006; and No. 2007-000621, filed Jan. 5, 2007, the entire contents of both which are incorporated herein by reference.

### BACKGROUND OF THE INVENTION

1. Field of the Invention

The present invention relates to a technology of combining a plurality of images, and in particular, to a technology by which oblique images can be precisely stuck to one another to be simply combined.

2. Description of the Related Art

Conventionally, in order to acquire an omnidirectional image, a plurality of images obtained by photographing the periphery such that a camera is set so as to not move its own central position while varying an angle of depression and an angle of elevation thereof, have been stuck to one another (Jpn. Pat. Appln. KOKAI Publication No. 11-213141).

### BRIEF SUMMARY OF THE INVENTION

According to a first aspect of the present invention, there is provided an image combining apparatus which combines a plurality of images photographed by a photographic device, the image combining apparatus comprising: a frame display unit which generates a virtual three-dimensional space on a display on which an image is displayed, the frame display unit displaying a spherical surface or a frame expressing a spherical surface in the virtual three-dimensional space; an image selection unit which selects images; an image arrangement unit which arranges the images selected by the image selection unit on the spherical surface or the frame expressing a spherical surface; a visual point moving unit which moves a visual point from which the spherical surface or the frame expressing a spherical surface is observed; an operating unit which, in accordance with an operation instruction, carries out a rotating operation, or a parallel moving operation onto the images arranged on the spherical surface or the frame expressing a spherical surface by the image arrangement unit; and a combining unit which combines the plural images operated by the operating unit into one image.

According to a second aspect of the present invention, there is provided an image combining method of an image processing apparatus for processing a plurality of images photographed by a photographic device, the method comprising: generating a virtual three-dimensional space on a display on which an image is displayed, and displaying a spherical surface or a frame expressing a spherical surface in the virtual three-dimensional space; selecting images; arranging the selected images on the spherical surface or the frame expressing a spherical surface; moving a visual point from which the spherical surface or the frame expressing a spherical surface is observed; carrying out a rotating operation, or a parallel moving operation onto the images arranged on the spherical surface or the frame expressing a spherical surface, in accordance with an operation instruction; and combining the plural operated images into one image.

According to a third aspect of the present invention, there is provided a storage medium having stored therein a program to be executed by an image processing apparatus for processing a plurality of images photographed by a photographic device, the program comprising: a frame display step of generating a virtual three-dimensional space on a display on which an image is displayed, and of displaying a spherical surface or a frame expressing a spherical surface in the virtual three-dimensional space; an image selecting step of selecting images; an image arranging step of arranging the images selected in the image selecting step on the spherical surface or the frame expressing a spherical surface; a visual point moving step of moving a visual point from which the spherical surface or the frame expressing a spherical surface is observed; an operating step of, in accordance with an operation instruction, carrying out a rotating operation, or a parallel moving operation onto the images arranged on the spherical surface or the frame expressing a spherical surface in the image arranging step; and a combining step of combining the plural images operated in the operating step into one image.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view for explaining a display method in a bird's-eye mode;

FIG. 2 is a view for explaining a display method in a panorama mode;

FIG. 3 is a view showing a configuration of an image combining screen by an image combining method according to a first embodiment of the present invention;

FIG. 4 is a diagram showing a coordinate system in a bird's-eye mode;

FIG. 5 is a diagram in which a photographed image after rotation is expressed by a world coordinate system;

FIG. 6 is a diagram showing a coordinate system in a panorama mode;

FIG. 7 is a diagram showing correspondences between a world coordinate system and a local coordinate system;

FIG. 8 is a diagram showing a configuration of an image processing apparatus;

FIG. 9 is a flowchart showing a main procedure of image combining processing;

FIG. 10 is a flowchart showing a procedure for displaying in a display area on an image combining screen; and

FIG. 11 is a flowchart showing a procedure for resizing a sphere.

### DETAILED DESCRIPTION OF THE INVENTION

### First Embodiment

A basic principle of an image combining method according to a first embodiment of the present invention will be described.

The image combining method includes two display modes, i.e., a bird's-eye mode and a panorama mode. A user executes an operation of sticking photographed images each other in one of these modes.

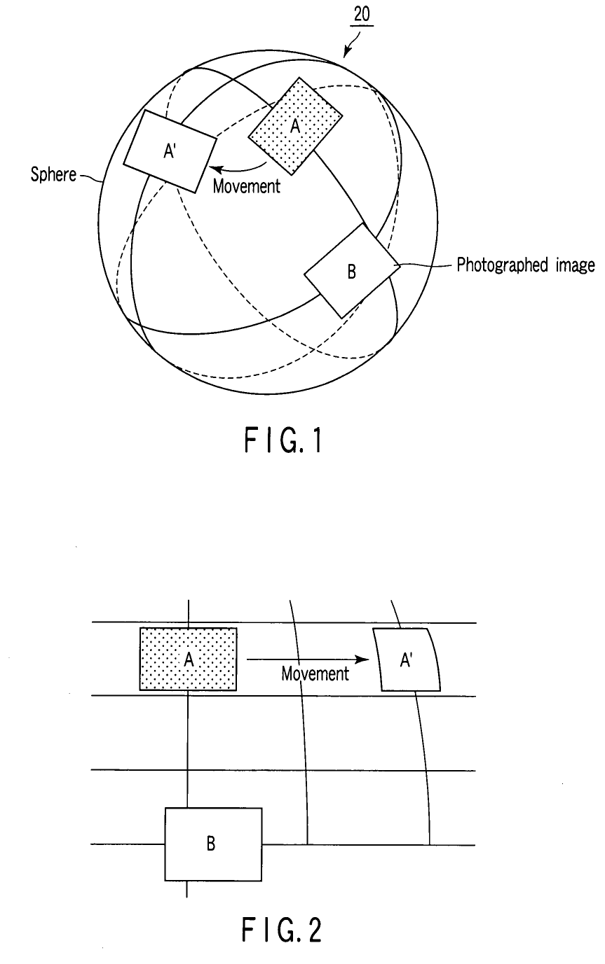

FIG. 1 is a view for explaining a display method in the bird's-eye mode.

In the bird's-eye mode, it is possible for a user to project and stick photographed images on a surface of a spherical surface 20 expressing all directions, and it is further possible for the user to observe the photographed images from outside of the spherical surface 20.

The user can move the photographed images along the surface of the spherical surface 20. The user can also turn the photographed images in a clockwise direction and a counterclockwise direction in order to correct the inclinations of the photographed images.

Further, it is possible to change a position of visual point provided outside the spherical surface 20. Namely, a direction of visual line can be rotated with the center of the spherical surface 20 serving as the origin, and it is possible to make the visual point approach or back away from the spherical surface 20.

Note that the spherical surface itself can be enlarged or reduced. Then, the images projected on the spherical surface are updated in accordance with a size of the spherical surface 20. This makes it possible to adjust the sphere of a size corresponding to an angular field of view of a photographed image.

In FIG. 1, a photographed image A and a photographed image B are stuck on the spherical surface 20. It is possible for the user to move the photographed image A along a parallel of latitude, and to stick it on a position expressed by a photographed image A′.

In this way, the user can move a photographed image to an arbitrary position on a spherical surface imitating a three-dimensional space, which allows images to be simply and precisely combined.

FIG. 2 is a view for explaining a display method in the panorama mode.

In the panorama mode, the user sticks photographed images onto the inner surface of the spherical surface 20 expressing all directions, and observes the photographed images from inside of the spherical surface 20. A screen is arranged at the inside of the spherical surface 20, and the user observes images vertically projected from the images on the spherical surface on the screen, from behind the screen. A range of visual field of the observation is the same as a range when the photographed images projected on the screen are observed.

The user can move the photographed images along the surface of the spherical surface 20. The user can also turn the photographed images in a clockwise direction and a counterclockwise direction in order to correct the inclinations of the photographed images.

Further, it is possible to change a position of visual point arranged at the inside of the spherical surface 20. More specifically, it is possible to rotate the spherical surface 20 in a horizontal direction and a vertical direction, and also to make a visual point and the screen approach or back away from the spherical surface 20.

The spherical surface 20 itself can be enlarged or reduced. This makes it possible to adjust the sphere of a size corresponding to an angular field of view of a photographed image.

In FIG. 2, the photographed image A and the photographed image B are stuck on the spherical surface 20. The user can move the photographed image A along a parallel of latitude, and stick it on a position expressed by the photographed image A′.

Next, a user interface for realizing the above-described operations will be described.

In the image combining method according to the embodiment of the invention, the user executes an image processing operation on the basis of an image combining screen displayed on a display unit of an image processing apparatus.

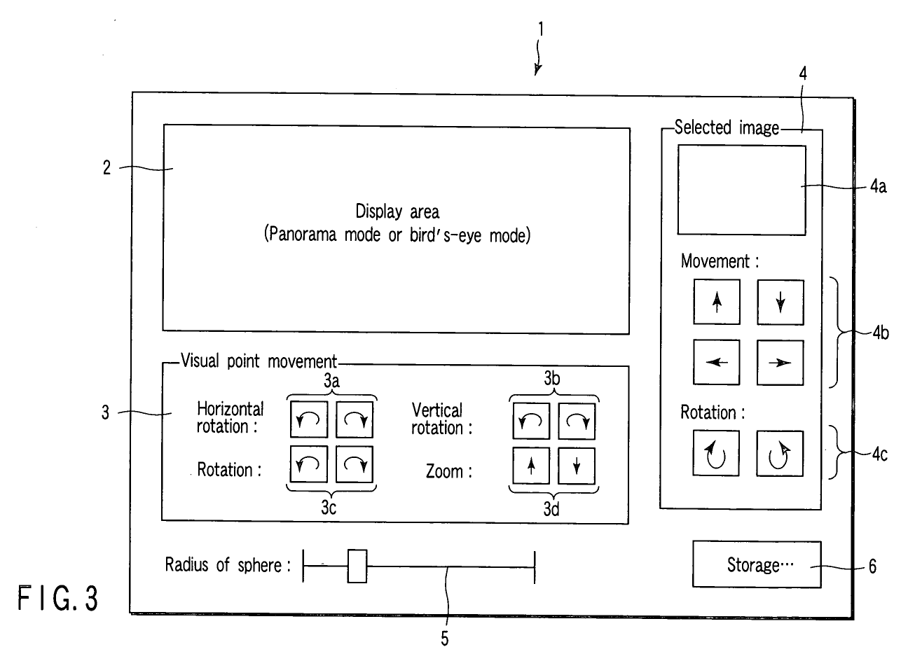

FIG. 3 is a diagram showing a configuration of the image combining screen according to the image combining method according to the first embodiment of the invention.

An image combining screen 1 includes a display area 2, a visual point operating area 3, an image operating area 4, a resizing slide bar 5, and a storage button 6.

A picture obtained by observing the spherical surface 20 in the bird's-eye mode or the panorama mode is displayed on the display area 2.

A horizontal rotation button 3a, a vertical rotation button 3b, a rotation button 3c, and a zoom button 3d are provided in the visual point operating area 3. When the horizontal rotation button 3a is operated, an azimuth angle of visual line is changed and a direction of the visual line rotates from side to side. When the vertical rotation button 3b is operated, an elevation angle of visual line is changed and a direction of the visual line rotates up and down. When the rotation button 3c is operated, a visual field rotates clockwise or counterclockwise around the central position of the display area 2. When the zoom button 3d is operated, a visual field is enlarged or reduced. The enlargement of the visual field corresponds to that the visual point is made to approach the spherical surface 20, and the reduction of the visual field corresponds to that the visual point is made to back away from the spherical surface 20.

A selected image display area 4a, a moving operation button 4b, and a rotating operation button 4c are provided in the image operating area 4. A selected image which is a photographed image to be operated is displayed on the selected image display area 4a. Operating the moving operation button 4b allows the selected image to be moved along a parallel of latitude and a meridian of the spherical surface 20. Operating the rotating operation button 4c allows the selected image to be rotated to the right or the left centering abound the central position thereof.

When the resizing slide bar 5 is operated, the radius of the spherical surface 20 can be enlarged or reduced. Even when the radius of the spherical surface 20 is changed, a size of the photographed image is not changed, but as is.

The storage button 6 is operated to thereby store a combined image.

Next, a coordinate transformation method for realizing the above-described operations will be described.

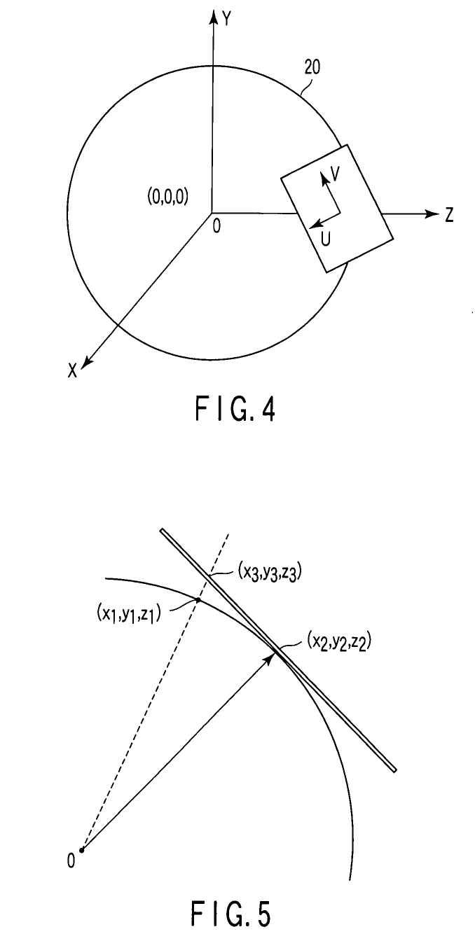

FIG. 4 is a diagram showing a world coordinate system and a local coordinate system which is peculiar to a photographed image.

The world coordinate system is a three-dimensional coordinate system (X, Y, Z) fixed to the spherical surface 20 with the center of the spherical surface 20 serving as the origin. Note that the X-axis, Y-axis, and Z-axis are in a left-hand system as shown in FIG. 4.

On the other hand, the local coordinate system is a two-dimensional coordinate system (U, V) provided on a photographed image.

In the world coordinate system, an initial position of the photographed image is set as follows.

(1) The center of the photographed image is set as the origin of the local coordinate system (U-axis, V-axis). (2) The photographed image contacts the spherical surface 20. (3) The center of the photographed image is on the Z-axis, and the U-axis and the V-axis are perpendicular to the Z-axis. (4) The U-axis is parallel to the X-axis, and the V-axis is parallel to the Y-axis.

Suppose that a matrix in which the photographed image is rotated by θ around the X-axis along the spherical surface is Mx(θ), and a matrix in which the photographed image is rotated by θ around the Y-axis is My(θ), and a matrix in which the photographed image is rotated by θ around the Z-axis is Mz(θ). Because the photographed image moves in a three-dimensional space, the local coordinate system of the photographed image is extended in three dimensions of (U, V, W) for convenience.

These matrices are expressed by formula (1) to formula (3).

$$\begin{matrix}Mx ( θ ) = [ \begin{matrix}1 & 0 & 0 \\ 0 & cos θ & - sin θ \\ 0 & sin θ & cos θ\end{matrix} ] & formula ( 1 ) \\ My ( θ ) = [ \begin{matrix}cos θ & 0 & sin θ \\ 0 & 1 & 0 \\ - sin θ & 0 & cos θ\end{matrix} ] & formula ( 2 ) \\ Mz ( θ ) = [ \begin{matrix}cos θ & - sin θ & 0 \\ sin θ & cos θ & 0 \\ 0 & 0 & 1\end{matrix} ] & formula ( 3 )\end{matrix}$$

Now, given that the Z-axis is taken to the north pole direction and the X-axis is taken to a direction of an intersection between the equator and a meridian at longitude 0 degree, the Y-axis is taken to a direction of an intersection between the equator and a meridian at longitude 90 degrees west. Then, the photographed image is placed at the north pole which is the initial position such that directions of the U-axis and the V-axis are made to be the same directions as those of the X-axis and the Y-axis.

First, the photographed image is rotated by θ3 in a clockwise direction abound the center of the photographed image. Next, the photographed image is rotated by θ2 along a meridian at longitude 0 degree. For the last time, the photographed image is rotated by θ1 in a clockwise direction as seen from the north pole along a parallel of latitude. These three rotations are expressed by a matrix M of formula (4).

Points after the above-described rotating operations are applied to the point (u, y, r) on the photographed image at the initial position expressed by the local coordinate system of the photographed image are expressed by a world coordinate system, which leads to formula (5). This formula (5) shows an operation in which the original photographed image is moved along the spherical surface 20 and rotation is applied thereto.

$$\begin{matrix}M = Mz ( {θ}_{1} ) \cdot My ( {θ}_{2} ) \cdot Mz ( {θ}_{3} ) & formula ( 4 ) \\ [ \begin{matrix}x \\ y \\ z\end{matrix} ] = M [ \begin{matrix}u \\ v \\ r\end{matrix} ] & formula ( 5 )\end{matrix}$$

wherein r denotes a radius of a sphere

Then, the coordinate (x₂, y₂, z₂) after the center of the photographed image is operated to rotate are expressed by formula (6).

$$[ \begin{matrix}{x}_{2} \\ {y}_{2} \\ {z}_{2}\end{matrix} ] = M [ \begin{matrix}0 \\ 0 \\ r\end{matrix} ] \qquad formula ( 6 )$$

A plane surface in which a vector passing through the coordinate (x₂, y₂, z₂) from the center of the spherical surface 20 is regarded as a normal vector, includes a plane surface of the photographed image, and is expressed by formula (7).

x₂x+y₂y+z₂z=x₂²+y₂²+z₂² formula (7)

FIG. 5 is a diagram in which the photographed image after the rotation of formula (4) is expressed by a world coordinate system.

A straight line passing through point (x₁, y₁, z₁) on the spherical surface from the center of the spherical surface 20 is expressed by formula (8).

$$\frac{x}{{x}_{1}} = \frac{y}{{y}_{1}} = \frac{z}{{z}_{1}} \qquad formula ( 8 )$$

Accordingly, the coordinate (x₃, y₃, z₃) of an intersection between the straight line and the plane surface of formula (7) can be found by formula (9).

$$\begin{matrix}[ \begin{matrix}{x}_{3} \\ {y}_{3} \\ {z}_{3}\end{matrix} ] = A [ \begin{matrix}{x}_{1} \\ {y}_{1} \\ {z}_{1}\end{matrix} ] = \frac{{x}_{2}^{2} + {y}_{2}^{2} + {z}_{2}^{2}}{{x}_{1} {x}_{2} + {y}_{1} {y}_{2} + {z}_{1} {z}_{2}} [ \begin{matrix}{x}_{1} \\ {y}_{1} \\ {z}_{1}\end{matrix} ] & formula ( 9 ) \\ [ \begin{matrix}{x}_{1} \\ {y}_{1} \\ {z}_{1}\end{matrix} ] = {A}^{- 1} [ \begin{matrix}{x}_{3} \\ {y}_{3} \\ {z}_{3}\end{matrix} ] & formula ( 10 )\end{matrix}$$

In the embodiment, pixel information of the respective points on the photographed image is projected centrally on the spherical surface 20. Because the coordinate values in the local coordinate system of the points on the photographed image are not changed by a rotating operation on the spherical surface 20, the coordinate in the world coordinate system of the point of the coordinate (u, v) in the local coordinate system can be calculated by formula (5). Accordingly, the world coordinate on the spherical surface 20 is calculated by applying formula (10) to the coordinate obtained by formula (5), and the pixel information of the coordinate (u, v) of the photographed image is projected on the point.

Here, the pixel information means the brightness of pixels and the color values of RGB respective colors. Accordingly, it is possible to project a photographed image on an arbitrary position on the spherical surface 20 by using formula (1) to formula (10).

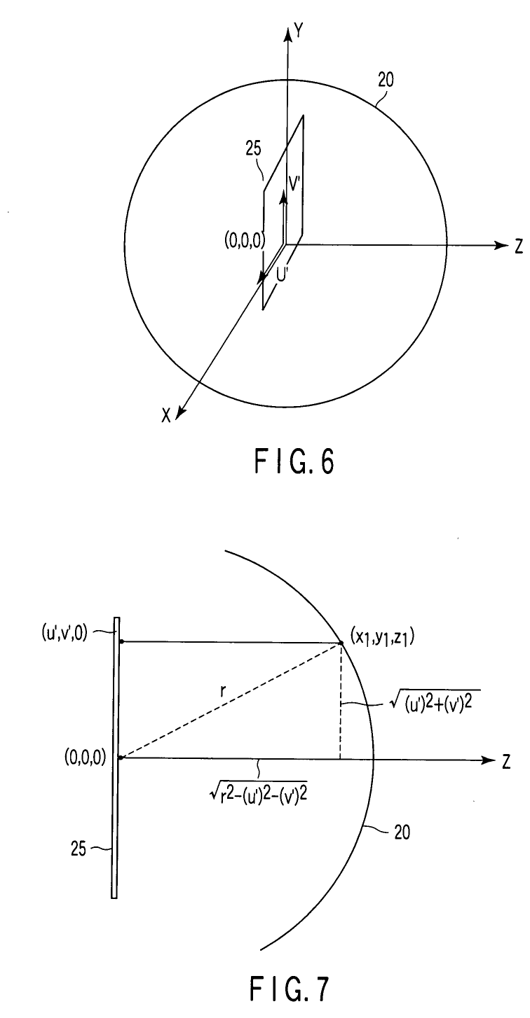

FIG. 6 is a diagram showing a local coordinate system of a screen 25 in the panorama mode. The screen 25 expresses a range corresponding to a visual field, and is arranged in the spherical surface 20 in the panorama mode. A two-dimensional local coordinate system peculiar to the screen 25 is determined to be (U′, V′). Note that the local coordinate system is made to be (U′, V′, W′) in three dimensions for convenience in the same way as the local coordinate system of the photographed image. This local coordinate system (U′, V′, W′) is a left-hand system in the same way as the world coordinate system, and the U′-axis and the V′-axis are on the screen and the center of the screen 25 is the origin.

Suppose that, in the world coordinate system, an initial position and a direction of the screen 25 are set as follows.

(1) The center of the screen 25 is positioned at the center of the spherical surface 20. (2) The directions of the U′-axis, the V′-axis, and the W′-axis in the local coordinate system of the screen are respectively the same as the directions of the X-axis, the Y-axis, and the Z-axis in the world coordinate system. Namely, the local coordinate system of the screen and the world coordinate system are coincided with each other at the initial position of the screen 25.

In the present embodiment, the pixel information projected centrally on the spherical surface 20 from the photographed image is vertically projected on the screen 25. Therefore, the position of the projected two-dimensional coordinate does not depend on a position in the W-axis direction of the screen.

FIG. 7 is a diagram showing correspondences between the world coordinate system and the local coordinate system of the screen 25. At the initial position, the point (x₁, y₁, z₁) on the spherical surface 20 is expressed by formula (11) in the local coordinate system of the screen 25.

$$\begin{matrix}[ \begin{matrix}{x}_{1} \\ {y}_{1} \\ {z}_{1}\end{matrix} ] = [ \begin{matrix}{u}^{′} \\ {v}^{′} \\ {w}^{′}\end{matrix} ] = [ \begin{matrix}{u}^{′} \\ {v}^{′} \\ \sqrt{{r}^{2} - {( {u}^{′} )}^{2} - {( {v}^{′} )}^{2}}\end{matrix} ] & ( 11 ) \\ Su ( φ ) = [ \begin{matrix}1 & 0 & 0 \\ 0 & cos φ & sin φ \\ 0 & - sin φ & cos φ\end{matrix} ] & ( 12 ) \\ Sv ( φ ) = [ \begin{matrix}cos φ & 0 & - sin φ \\ 0 & 1 & 0 \\ sin φ & 0 & cos φ\end{matrix} ] & ( 13 ) \\ Sw ( φ ) = [ \begin{matrix}cos φ & sin φ & 0 \\ - sin φ & cos φ & 0 \\ 0 & 0 & 1\end{matrix} ] & ( 14 ) \\ [ \begin{matrix}{u}_{1}^{′} \\ {v}_{1}^{′} \\ {w}_{1}^{′}\end{matrix} ] = Sw ( {φ}_{3} ) \cdot Sv ( {φ}_{2} ) \cdot Su ( {φ}_{1} ) [ \begin{matrix}{x}_{1} \\ {y}_{1} \\ {z}_{1}\end{matrix} ] & ( 15 )\end{matrix}$$

On the other hand, a matrix Su(φ) in which the local coordinate system of the screen 25 is rotated to the left by φ around the U′-axis is expressed by formula (12). A matrix Sv(φ) in which the local coordinate system of the screen 25 is rotated to the left by φ around the V′-axis is expressed by formula (13). A matrix Sw(φ) in which the local coordinate system of the screen 25 is rotated to the left by φ around the W′-axis is expressed by formula (14). Accordingly, after the screen 25 is rotated to the left by φ₁ around the U′-axis from the initial position, the screen 25 is rotated to the left by φ₂ around the V′-axis, and is further rotated to the left by φ₃ around the W′-axis. In this case, the point (x₁, y₁, z₁) on the spherical surface 20 is expressed by formula (15) in the local coordinate system of the screen.

Assuming that the screen is observed from the minus side of the W′-axis, a right direction of visual field is taken to the U′-axis direction and an upward direction of visual field is taken to the V′-axis direction. Rotating the screen to the left around the U′-axis corresponds to rotating the visual field downward. Rotating the screen to the left around the V-axis corresponds to rotating the visual field in a clockwise direction. Rotating the screen to the left around the W′-axis corresponds to rotating the visual field in a counterclockwise direction.

Further, the image on the spherical surface is projected horizontally on the screen. Movements of a visual field to the left, right, top and bottom directions correspond to that the screen 25 is moved along the U′-axis and the V′-axis. Zooming of a visual field corresponds to that enlargement or reduction of the screen 25. The screen 25 has been arranged in the spherical surface 20 in the above-described descriptions. Even when the screen 25 is at the outer side of the spherical surface 20, it is the same in a case where an image on the spherical surface 20 is vertically projected on the screen. However, in the case of the panorama mode, photographed images are arranged so as to face the inner side of the spherical surface 20, and in the case of the bird's-eye mode, photographed images are arranged so as to face the outer side of the spherical surface 20.

As described above, it is possible to arrange a photographed image at an arbitrary position on the spherical surface to project the photographed image on the spherical surface 20 by using formula (1) to formula (10), and it is possible to observe the image projected on the spherical surface 20 from an arbitrary position by using formula (11) to formula (15).

Subsequently, a configuration of an image processing apparatus for realizing the image combining method, and a main procedure thereof will be described.

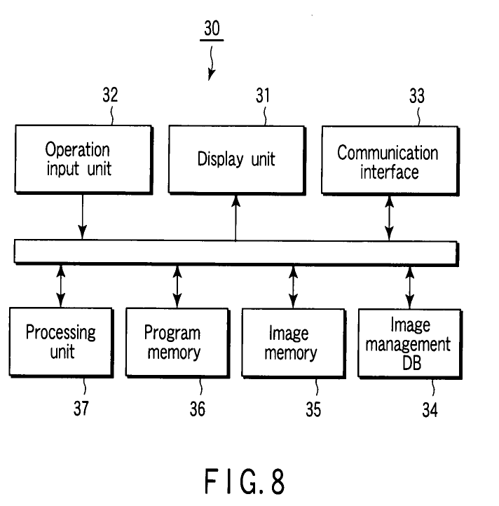

FIG. 8 is a diagram showing a configuration of an image processing apparatus 30. The image processing apparatus 30 has a display unit 31, an operation input unit 32, a communication interface 33, an image management DB 34, an image memory 35, a program memory 36, and a processing unit 37.

The display unit 31 is a CRT or a crystal liquid display on which the image combining screen 1 is displayed. The operation input unit 32 is an input device such as a keyboard or a mouse for receiving an operator guidance input from a user. The communication interface 33 is an interface for transmitting and receiving information such as image files via communication to and from an external device (not shown) such as, for example, a digital camera. The image management DB 34 stores management information such as addresses of stored images. The image memory 35 is a buffer memory in which information on operations or information required for image combining processing is stored. The program memory 36 stores a program for controlling the respective functions of the image processing apparatus 30. The processing unit 37 overall controls the operations of the image processing apparatus 30.

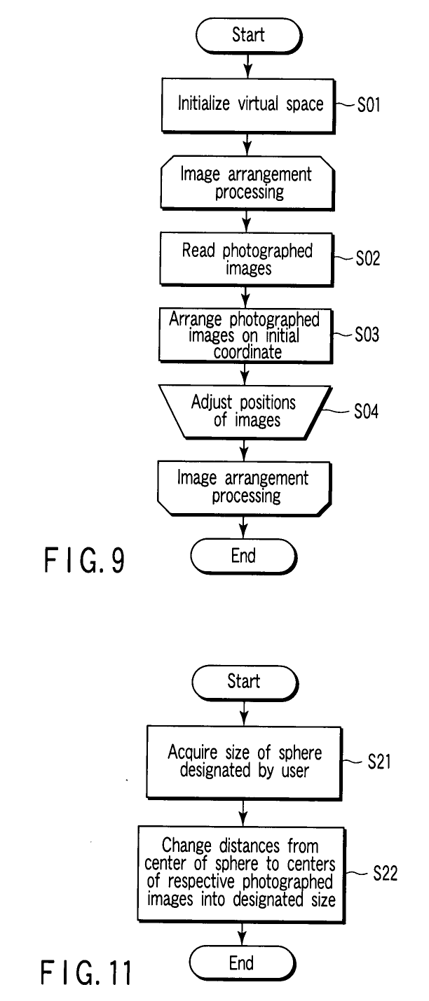

Next, the general procedures of the image combining processing will be described with reference to FIGS. 9 to 11. Note that the processing which will be described hereinafter is processing with respect to main functions among image combining processing functions. Accordingly, even functions, which are not described in the following description, but which are described in the description of FIGS. 1 to 8 are included in the image combining processing functions.

FIG. 9 is a flowchart showing a main procedure of the image combining processing. When the user starts up the image processing apparatus 30 to display the image combining screen 1 on the display unit 31, the image combining processing is started up.

In step S01, a virtual space is initialized. Namely, the spherical surface 20 or a frame showing a spherical surface serving as a base is displayed, and parallels of latitude and meridians serving as references are shown on the spherical surface.

Then, image arrangement processing shown in steps S02 to S04 is executed repeatedly a number of times corresponding to the number of photographed images.

When the user selects a photographed image, the photographed image is read in step S02, and the photographed image is arranged at an initial coordinate position corresponding to a display mode in step S03. Then, color values of respective points on the photographed image are projected centrally at corresponding positions on the spherical surface, and subsequently, the projected image on the spherical surface is moved in accordance with an image moving operation by the user in step S04.

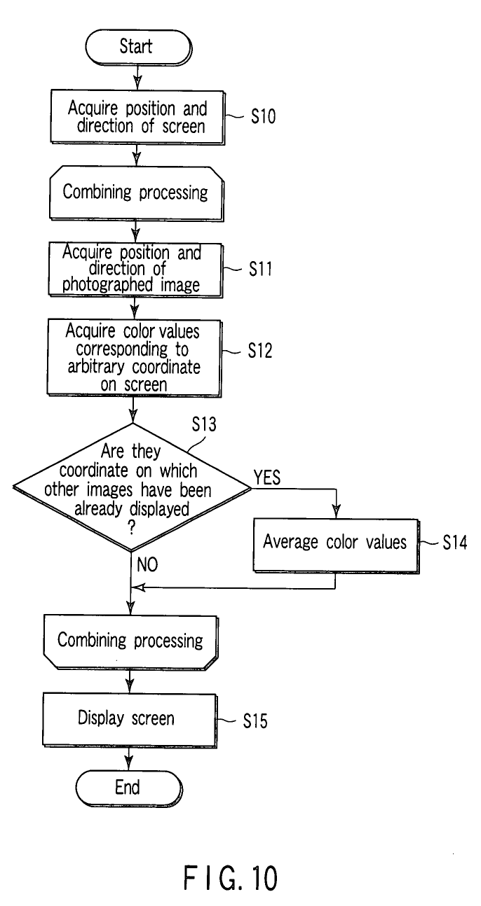

FIG. 10 is a flowchart showing a procedure for displaying in the display area 2 on the image combining screen. This processing is executed in time with the processing of moving the photographed image described above.

In step S10, the current position and direction of the screen are acquired. Then, the combining processing in steps S11 to S14 is executed for each photographed image to be combined.

In step S11, the current position and direction of the photographed image are acquired. Then, in step S12, color values on the screen 25 of an image obtained in such a manner that color values of the photographed image are centrally projected on the spherical surface 20 and further vertically projected on the screen 25, are calculated.

In step S13, it is examined whether or not color values of other photographed images have been already projected onto the position on the screen 25 on which the photographed image has been projected.

In the case of Yes in step S13, i.e., in the case where color values of other photographed images have been already projected, color values projected from the respective photographed images are averaged with respect to the overlapped area in step S14. On the other hand, in the case of No in step S13, i.e., in the case where other photographed images have not been projected, the currently projected color values are regarded as color values at that position on the screen. When the projection processings from all the photographed images onto the screen 25 have been completed, the screen 25 is displayed in the display area 2 in step S15. As a consequence, it is possible for the user to easily confirm whether or not the photographed images are precisely stuck to one another on the spherical surface 20.

FIG. 11 is a flowchart showing a procedure of resizing the spherical surface 20.

When the user operates the resizing slide bar 5, a size of the spherical surface 20 designated by the user is acquired in step S21. Then, distances from the center of the spherical surface 20 to the centers of the respective photographed images are changed to be the size designated by the user in step S22.

According to the embodiment, the following effect can be exerted.

A virtual three-dimensional space is generated, a sphere is formed in the three-dimensional space, and a photographed image is projected on the sphere, which makes it possible to carry out a moving operation.

Because a visual point observing the sphere can be changed, it is possible for the user to observe and operate the projected image projected on the spherical surface from a position easy to view.

Accordingly, it is possible to combine photographed images so as to be free of influence of an elevation angle which has been problematic in combining on a plane surface.

Although, in the above-describe embodiment, the images have been combined on the spherical surface, those may be combined on a frame expressing a spherical surface.

Note that the respective functions described in the above-describe embodiment may be configured by using hardware, and further, those may be realized by causing a computer to read a program having the respective functions described therein by using software. Further, the respective functions may be structured by appropriately selecting one of software and hardware.

Moreover, the respective functions may be realized by causing a computer to read a program stored on a storage medium (not shown). Here, with respect to a storage medium in the embodiment, any storage medium on which a program can be recorded and which is computer readable suffices in any format of the recording system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image combining apparatus which combines a plurality of images photographed by a photographic device, the image combining apparatus comprising:
a frame display unit which generates a virtual three-dimensional space on a display on which an image is displayed, the frame display unit displaying a spherical surface or a frame expressing a spherical surface in the virtual three-dimensional space;
an image selection unit which selects images;
an image arrangement unit which arranges the images selected by the image selection unit on the spherical surface or the frame expressing a spherical surface;
a visual point moving unit which moves a visual point from which the spherical surface or the frame expressing a spherical surface is observed;
an operating unit which, in accordance with an operation instruction, carries out a rotating operation, or a parallel moving operation onto the images arranged on the spherical surface or the frame expressing a spherical surface by the image arrangement unit; and
a combining unit which combines the plural images operated by the operating unit into one image.

2. The image combining apparatus according to claim 1, further comprising:
a view image generating unit which generates a view image when at least a part of the image combined by the combining unit is observed from inside of the spherical surface or from outside of the spherical surface; and
a view image display unit which displays the image generated by the view image generating unit on the display.

3. The image combining apparatus according to claim 2, wherein the plurality of images photographed by the photographic device are images photographed from a same position.

4. The image combining apparatus according to claim 2, wherein the image combined by the combining unit is an image covering the entire spherical surface.

5. An image combining method of an image processing apparatus for processing a plurality of images photographed by a photographic device, the method comprising:
generating a virtual three-dimensional space on a display on which an image is displayed, and displaying a spherical surface or a frame expressing a spherical surface in the virtual three-dimensional space;
selecting images;
arranging the selected images on the spherical surface or the frame expressing a spherical surface;
moving a visual point from which the spherical surface or the frame expressing a spherical surface is observed;
carrying out a rotating operation, or a parallel moving operation onto the images arranged on the spherical surface or the frame expressing a spherical surface, in accordance with an operation instruction; and
combining the plural operated images into one image.

6. The image combining method according to claim 5, further comprising:
generating a view image when at least a part of the combined image is observed from inside of the spherical surface or from outside of the spherical surface; and
displaying the generated image on the display.

7. The image combining method according to claim 6, wherein the plurality of images photographed by the photographic device are images photographed from a same position.

8. The image combining method according to claim 6, wherein the image to be combined is an image covering the entire spherical surface.

9. A storage medium having stored therein a program to be executed by an image processing apparatus for processing a plurality of images photographed by a photographic device, the program comprising:
a frame display step of generating a virtual three-dimensional space on a display on which an image is displayed, and of displaying a spherical surface or a frame expressing a spherical surface in the virtual three-dimensional space;
an image selecting step of selecting images;
an image arranging step of arranging the images selected in the image selecting step on the spherical surface or the frame expressing a spherical surface;
a visual point moving step of moving a visual point from which the spherical surface or the frame expressing a spherical surface is observed;
an operating step of, in accordance with an operation instruction, carrying out a rotating operation, or a parallel moving operation onto the images arranged on the spherical surface or the frame expressing a spherical surface in the image arranging step; and
a combining step of combining the plural images operated in the operating step into one image.

10. The storage medium according to claim 9, further comprising:
a view image generating step of generating a view image when at least a part of the image combined in the combining step is observed from inside of the spherical surface or from outside of the spherical surface; and
a view image display step of displaying the image generated in the view image generating step on the display.

11. The storage medium according to claim 10, wherein the plurality of images photographed by the photographic device are images photographed from a same position.

12. The storage medium according to claim 10, wherein the image to be combined in the combining step is an image covering the entire spherical surface.
